(19) United States
(12) Patent Application Publication
(10) Pub. No.: US 2019/0364368 A1
(43) Pub. Date: Nov. 28, 2019

(54) Speaker Cone and a Speaker Having the Same

(71) Applicant: Ching Shan Huang, Dongguan (CN)

(72) Inventor: Ching Shan Huang, Dongguan (CN)

(21) Appl. No.: 16/131,577

(22) Filed: Sep. 14, 2018

(30) Foreign Application Priority Data
May 22, 2018 (CN) 201810497000.5

(51) Int. Cl. H04R 9/06; H04R 7/12; H04R 7/16; H04R 9/02

(52) U.S. Cl. CPC H04R 9/06; H04R 9/025; H04R 7/16; H04R 7/127

(57) ABSTRACT

A speaker cone comprises an upper speaker cone and a lower speaker cone, which are arranged in a horn shape. The upper and lower speaker cones are disposed symmetrically with respect to the center thereof. The peak of the upper speaker cone is opposite to and adhered to the peak of the lower speaker cone to form a speaker cone assembly, and the middle portion of which extends out a mounting cylinder. In comparison, the upper and lower speaker cones in the symmetric configuration replace the single-layer speaker cone used in the prior art. This effectively reduces the area occupied by the speaker cone in the height direction. In addition, the double speaker cone structure enhances the sound level while reduces the distortion rate of the speaker, greatly improving the quality of sound. A speaker using the speaker cone is also provided.

### FIELD OF THE INVENTION

The invention relates to the field of speaker technology and, in particular, to a speaker cone and a speaker having the same.

### BACKGROUND OF THE INVENTION

Speakers are widely used in a variety of audio equipment as electroacoustic transducers. With the development of technology and customer needs and in the trend of miniaturization of electronic products, consumers are turning their attention to light and portable audio products. As a source of sound, the ultra-thinness of speaker units is particularly critical.

Nowadays, the speakers on the market are comprised of a combination of convex cones of the paper or plastic basins and a convex basin frame. This structure increases the thickness of the entire speaker, rendering the speaker too large in volume. When assembled into audio or electrical equipment, it occupies too much space. When such a product is installed on a car or bus, it does not only increase the weight of the vehicle but also occupies space. In the event of an accident, the speaker is likely to cause fatal damages to the driver and passengers.

To ensure that it can be installed on ultra-thin electronics, the existing speakers have to reduce its size. However, the power is also reduced in proportion, resulting in an insufficient sound level. At the same time, the distortion rate of the speaker is also increased, greatly reducing the quality of sound.

Speaker cone is the main sounding component of the speaker. The speaker cone provides better output power and audio characteristics for the speaker. Hence, the sound quality of the speaker greatly depends on the speaker cone. The size of the speaker is also mainly determined by the structure and size of the speaker cone. Therefore, the speaker cone structure is especially critical for the preparation of a small, sound-efficient speaker.

### SUMMARY OF THE INVENTION

In view of the foregoing, an objective of the invention is to provide a small-sized, sound-efficient speaker cone. The invention also provides a speaker having the same.

The disclosed speaker cone comprises an upper speaker cone and a lower speaker cone, which are both arranged in a horn shape and disposed symmetrically with respect to the center thereof. The peak of the upper speaker cone is opposite to and adhered to the peak of the lower speaker cone to form a speaker cone assembly. The middle portion of the speaker cone assembly extends out a mounting cylinder.

The middle portion of the upper speaker cone is formed with a first through hole, which extends out a first annular mounting part in the direction of the lower speaker cone. The middle portion of the lower speaker cone is formed with a second through hole, which extends out a second annular mounting part in the direction of the upper speaker cone. The inner wall surface of the second annular mounting part extends out a mounting cylinder in the direction opposite to the upper speaker cone.

In an embodiment, the inner diameter of the first annular mounting part is equal to the outer diameter of the second annular mounting part. When assembled, the first annular mounting part is sleeved and adhered to the outer wall of the second annular mounting part.

In another embodiment, the outer diameter of the first annular mounting part is equal to the inner diameter of the second annular mounting part. When assembled, the first annular mounting part is inserted and adhered to the inner wall of the second annular mounting part.

In an embodiment, the middle portion of the upper speaker cone and/or the lower speaker cone is provided with an elastic wave.

At least one turn of first hanging edge is disposed at the edge of the upper speaker cone. At least one turn of second hanging edge is disposed at the edge of the lower speaker cone.

The cross section of the first hanging edge is the same as the cross section of the second hanging edge. Both the first hanging edge and the second hanging edge are hemispherical annular ridges.

In an embodiment, the first hanging edge and the second hanging edge are hemispherical annular ribs, and the radius of the first hanging edge is different from the radius of the second hanging edge.

The disclosed speaker comprises the above-mentioned speaker cone, a housing, a sound coil, a ring magnet, an audio device and a dust cover. The speaker cone assembly and the ring magnet are fixedly mounted in the housing. The sound coil is mounted on the outer wall of the mounting cylinder of the speaker cone assembly. The mounting cylinder of the speaker cone assembly is inserted into the ring magnet. The dust cover is disposed at an end of the mounting cylinder away from the magnet. The audio device is installed inside the housing and electrically connected to the sound coil.

The housing comprises an upper cover, a middle cover and a lower cover which are detachably connected from top to bottom. The upper cover or/and the lower cover are formed with a plurality of ventilation holes evenly distributed in a circular array and in the shape of petals.

In comparison, the upper and lower speaker cones in the symmetric configuration replace the single-layer speaker cone used in the prior art. This effectively reduces the area occupied by the speaker cone in the height direction. In addition, the double speaker cone structure enhances the sound level while reducing the distortion rate of the speaker, greatly improving the quality of sound.

Compared to the prior art, the disclosed speaker uses the disclosed speaker cones. While reducing the size thereof, the invention enhances the sound level and reduces the distortion rate thereof, greatly improving the sound quality.

### BRIEF DESCRIPTION OF THE DRAWINGS

FIG. 1 is an exploded view of the disclosed speaker;

FIG. 2 is a cross-sectional view of the disclosed speaker;

FIG. 3 is a schematic view of the speaker cone according to the invention;

FIG. 4 is a schematic view of the upper speaker cone according to the invention;

FIG. 5 is a schematic view of the lower speaker cone according to the invention; and

FIG. 6 is a cross-sectional view of the speaker cone assembly according to the invention.

### DESCRIPTION OF THE PREFERRED EMBODIMENTS

The aforementioned and other objectives and advantages of this disclosure will become clearer in light of the following detailed description of an illustrative embodiment of this invention described in connection with the drawings.

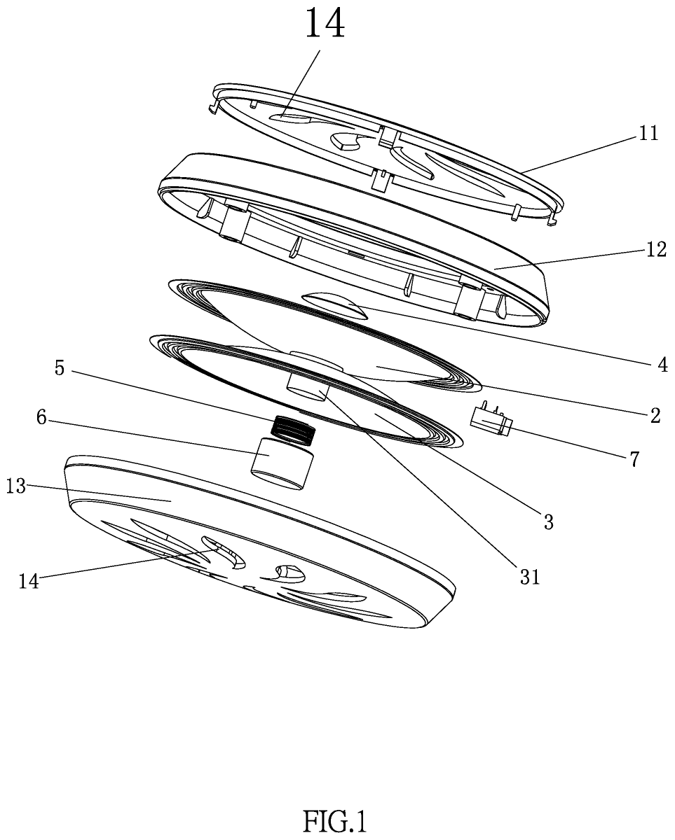

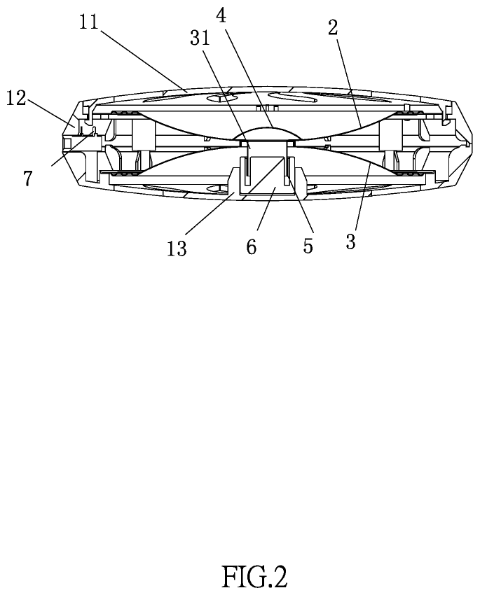

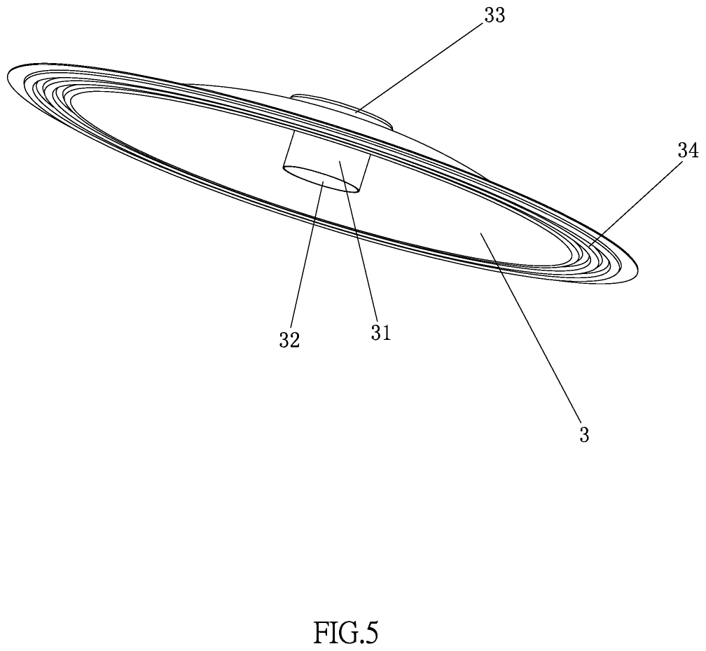

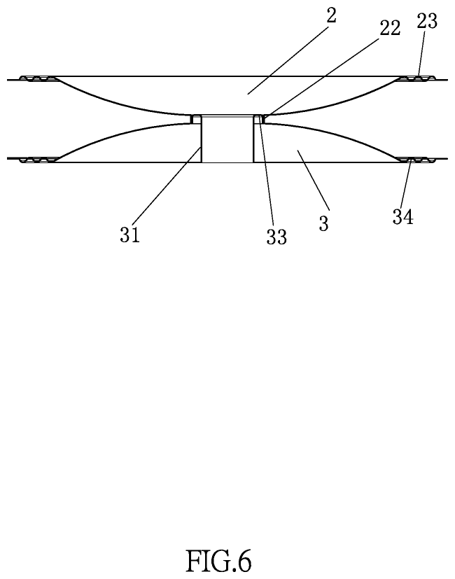

An explicit embodiment of the disclosed speaker is shown in FIGS. 1 to 6. The speaker includes a speaker cone assembly, a housing, a sound coil 5, a ring magnet 6, an audio device 7 and a dust cover 4. More explicitly, the housing includes from top to bottom an upper cover 11, a middle cover 12, and a lower cover 13 connected in a detachable way. In this embodiment, for the convenience of mass production and maintenance and tests of the speaker, the detachable connection among the upper cover 11, the middle cover 12, and the lower cover 13 in the form of an engagement connection. Of course, the detachable connection can also be achieved using screws. The connection method can be determined according to practical needs. To ensure good appearance and good sound effects of the speaker, the upper cover 11 and the lower cover 13 are formed with a plurality of ventilation holes arranged in a circular array and in the shape of petals. Having the ventilation holes in a circular array effectively increases the volume of the speaker, ensuring the sound level. The petal-shaped ventilation holes are not only pretty, but also effectively guide the audio output. Please refer to FIG. 2 for the structure of other parts of the invention. The speaker cone assembly and the ring magnet 6 are fixedly mounted inside the housing. The sound coil 5 is mounted on the outer wall of the mounting cylinder 31 of the speaker cone assembly, which is then inserted into the ring magnet 6. The dust cover 4 covers the end of the mounting cylinder 31 away from the ring magnet 6. The audio device 7 is mounted inside the housing and electrically connected to the sound coil 5. Of course, the invention can use structures other than that in this embodiment. For example, the housing has an open arrangement; that is, no bottom case is provided or no speaker housing is provided. Other electronic devices or household items are used instead as the outer casing of the speaker.

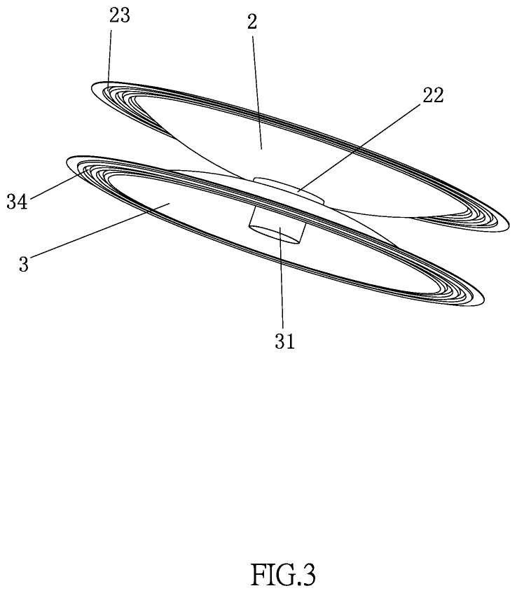

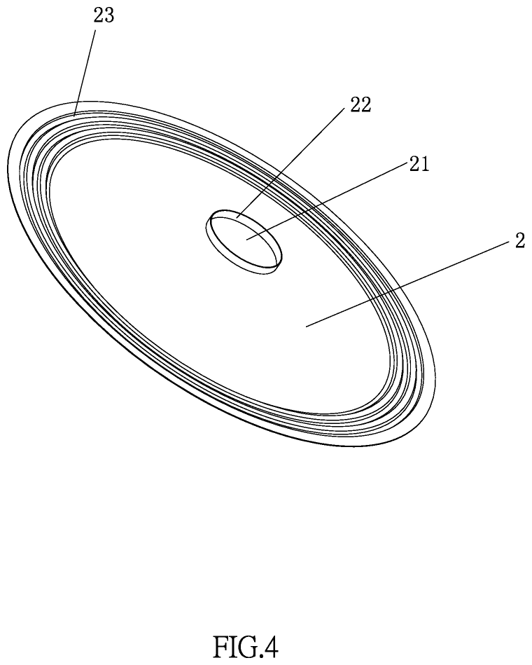

An embodiment of the disclosed speaker cone is illustrated in FIGS. 3 to 6. The speaker cone includes an upper speaker cone 2 and a lower speaker cone 3. Both the upper speaker cone 2 and the lower speaker cone 3 have a horn shape (in a bowl shape, having a slope, and having a peak). The upper speaker cone 2 and the lower speaker cone 3 are disposed symmetrically with respect to the center thereof. That is, the upper speaker cone 2 and the lower speaker cone 3 are disposed using the horizontal plane in FIG. 4 as the symmetric plane. Here the symmetry with respect to the center merely refers to the configuration of the upper speaker cone 2 and the lower speaker cone 3 without reference to whether the upper speaker cone 2 and the lower speaker cone 3 are the same in size and structure. To ensure the quality of sound, the central axis of the upper speaker cone 2 and the central axis of the lower speaker cone 3 coincide. The peak of the upper speaker cone 2 is opposite to and adhered to the peak of the lower speaker cone 3 to form the speaker cone assembly. The middle portion of the speaker cone assembly extends out a mounting cylinder 31. In this embodiment, for the convenience of mass production, the adhesion between the upper speaker cone 2 and the lower speaker cone 3 is achieved by attaching. There are of course other adhesion methods. For example, the adhesion can be achieved by ultrasonic welding, gluing, or some other auxiliary ways. The adhesion is to ensure the connection between the upper speaker cone 2 and the lower speaker cone 3 without affecting the material characteristics thereof. It can enhance the sound quality and level.

In a preferred embodiment, the middle portion of the upper speaker cone 2 is formed with a first through hole 21 that extends out a first annular mounting part 22 in the direction of the lower speaker cone 3. The middle portion of the lower speaker cone 3 is formed with a second through hole 32 that extends out a second annular mounting part 33 in the direction of the upper speaker cone 2. The inner wall surface of the second annular mounting part 33 extends out a mounting cylinder 31 in the direction opposite to the upper speaker cone 2. To further enhance sound effects and for the convenience of speaker cone assembly production, the inner diameter of the first annular mounting part 22 is equal to the outer diameter of the second annular mounting part 33. When assembled, the first annular mounting part 22 is mounted and adhered onto the outer wall of the second annular mounting part 33. In addition to the above-mentioned adhesion method, one can also have the diameter of the first annular mounting part 22 equal to the inner diameter of the second annular mounting part 33. When assembled, the first annular mounting part 22 is inserted into and adhered to the inner wall of the second annular mounting part 33. Using such a connection between the first annular mounting part 22 and the second annular mounting part 33 fully makes use of the softness of the speaker cones. While the speaker makes a loud sound, the adhesion between the upper speaker cone 2 and the lower speaker cone 3 is guaranteed to reduce the distortion rate of the speaker cones.

According to a preferred embodiment, the middle portion of the upper speaker cone or/and the lower speaker cone 3 is formed with an elastic wave to further increase the sound quality of the speaker.

In this embodiment, in order for the upper speaker cone 2 and the lower speaker cone 3 to have different timbres and different pitches, at least one turn of first hanging edge 23 is provided at the edge of the upper speaker cone 2, and at least one turn of second hanging edge 34 is provided at the edge of the lower speaker cone 3. The first hanging edge 23 and the second hanging edge 34 are both hemispherical annular ridges. In a preferred embodiment, two turns of the first hanging edge 23 of a smaller radius are provided on the upper speaker cone 2. The use of the first hanging edge 23 enables the upper speaker cone 2 to produce sounds with higher pitches. The lower speaker cone 3 is provided with one turn of the second hanging edge 34 with a radius greater than the radius of the first hanging edge 23. The lower speaker cone 3 can thus produce lower pitches. As a result, the speaker cones in this embodiment can produce sounds with both higher and lower pitches, enhancing the sound effects. In other words, not only is the invention reduce the speaker size, it also has better timbres. Of course, instead of different radii for the first hanging edge 23 and the second hanging edge 34, one can also have the same radius for the first hanging edge 23 and the second hanging edge 34. That is, the cross section of the first hanging edge 23 and the cross section of the second hanging edge 34 are the same. Such a structure can largely increase the sound level of the speaker.

In comparison, the upper speaker cone 2 and the lower speaker cone 3 disposed in the symmetric configuration replace the single-layer speaker cone used in the prior art. This effectively reduces the area occupied by the speaker cone in the height direction. In addition, the double speaker cone structure of the upper speaker cone 2 and the lower speaker cone 3 enhances the sound level while reducing the distortion rate of the speaker, greatly improving the quality of sound. Compared to the prior art, the disclosed speaker uses the disclosed speaker cones. While reducing the size thereof, the invention enhances the sound level and reduces the distortion rate thereof, greatly improving the sound quality.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. A speaker cone comprising an upper speaker cone and a lower speaker cone arranged in a horn shape and disposed symmetrically with respect to the center thereof, wherein the peak of the upper speaker cone is opposite to and adhered to the peak of the lower speaker cone to form a speaker cone assembly, and the middle portion of the speaker cone assembly extends out a mounting cylinder.

2. The speaker cone of claim 1, wherein the middle portion of the upper speaker cone is formed with a first through hole that extends out a first annular mounting part in the direction of the lower speaker cone, the middle portion of the lower speaker cone is formed with a second through hole that extends out a second annular mounting part in the direction of the upper speaker cone, and the inner wall surface of the second annular mounting part extends out a mounting cylinder in the direction opposite to the upper speaker cone.

3. The speaker cone of claim 2, wherein the inner diameter of the first annular mounting part is equal to the outer diameter of the second annular mounting part, and the first annular mounting part is mounted and adhered to the outer wall of the second annular mounting part.

4. The speaker cone of claim 2, wherein the outer diameter of the first annular mounting part is equal to the inner diameter of the second annular mounting part, and the first annular mounting part is inserted into and adhered to the inner wall of the second annular mounting part.

5. The speaker cone of claim 1, wherein the middle portion of the upper speaker cone and/or lower speaker cone is formed with an elastic wave.

6. The speaker cone of claim 1, wherein at least one turn of first hanging edge is disposed at the edge of the upper speaker cone, and at least one turn of second hanging edge is disposed at the edge of the lower speaker cone.

7. The speaker cone of claim 6, wherein the cross section of the first hanging edge is the same as the cross section of the second hanging edge, and both the first hanging edge and the second hanging edge are hemispherical annular ridges.

8. The speaker cone of claim 6, wherein the first hanging edge and the second hanging edge are hemispherical annular ribs, and the radius of the first hanging edge is different from the radius of the second hanging edge.

9. A speaker comprising the speaker cone of claim 1, a housing, a sound coil, a ring magnet, an audio device and a dust cover, wherein the speaker cone assembly and the ring magnet are fixedly mounted in the housing, the sound coil is mounted on the outer wall of the mounting cylinder of the speaker cone assembly, the mounting cylinder of the speaker cone assembly is inserted into the ring magnet, the dust cover is disposed at an end of the mounting cylinder away from the magnet, and the audio device is installed inside the housing and electrically connected to the sound coil.

10. The speaker of claim 9, wherein the housing includes an upper cover, a middle cover and a lower cover detachably connected from top to bottom, the upper cover or/and the lower cover are formed with a plurality of ventilation holes evenly distributed in a circular array and in the shape of petals.
